(19) United States
(12) Patent Application Publication
(10) Pub. No.: US 2018/0027068 A1
(43) Pub. Date: Jan. 25, 2018

(54) Grouping in a Communication System or Service

(71) Applicant: Microsoft Technology Licensing, LLC, Redmond, WA (US)

(72) Inventors: Vinay Kumar, Hyderabad (IN); Teekam Chand Goyal, Hyderabad (IN); Deepak Pratinidhi, Hyderabad (IN); Rakesh Midha, Hyderabad (IN); Anil Prasad, Hyderabad (IN); Jayawant Tewari, Hyderabad (IN); Prashant Gupta, Hyderabad (IN); Rajiv Kumar, Hyderabad (IN); Arun Rajappa, Hyderabad (IN); Praveen Upadhyay, Hyderabad (IN)

(73) Assignee: Microsoft Technology Licensing, LLC, Redmond, WA (US)

(21) Appl. No.: 15/397,145

(22) Filed: Jan. 3, 2017

(30) Foreign Application Priority Data
Jul. 19, 2016 (IN) 201641024648

(51) Int. Cl. H04L 29/08; H04L 29/06; G06Q 50/00; H04L 12/58

(52) U.S. Cl. CPC H04L 67/1044; H04L 51/04; H04L 63/104; H04L 65/403; H04L 51/38; G06Q 50/01; H04L 67/02; H04L 67/24

(57) ABSTRACT

In an instant messaging system users can be assigned groups to assist in distributing messages quickly and easily among designated users. A hierarchical grouping structure can be defined to provide increased control of groups and message routing. Parent and child groups can be defined, and a cascaded message flow can route messages from parent to child groups, but not from child to parent groups, which is particularly useful in very large systems with large numbers of users.

### RELATED APPLICATIONS

This application claims priority under 35 USC 119 or 365 to Indian Application No. 201641024648 filed Jul. 19, 2016, the disclosure of which is hereby incorporated by reference in its entirety.

### BACKGROUND

The present invention relates to network communication, and in particular instant messaging.

Instant messaging (IM) is a communication method and set of technologies which offers real time text transmission between two or more participants over a network, such as the internet. Instant messaging differs from other technologies such as email due to the perceived quasi-synchrony of the communications by the users More advanced instant messaging can add file transfer, clickable hyperlinks, Voice over IP, or video chat.

IM allows effective and efficient communication, usually allowing immediate receipt of acknowledgment or reply. However, IM is not necessarily supported by transaction control. It is usually possible to save a text conversation for later reference. Instant messages are often logged in a local message history, making it similar to the persistent nature of emails.

A popular feature of instant messaging is groups, whereby two or more users or clients can become members of an identifiable group. Messages can then be sent to an identified group, and are delivered or published to all the members of that group

### SUMMARY

It is identified herein that the functionality of existing groups in instant messaging is limited, and it is desirable to provide improved functionality.

Accordingly, in a first aspect of the invention there is provided a method comprising establishing a first group of users in an instant messaging environment; establishing a second group of users in the instant messaging environment; and establishing the second group as a member of the first group, in a hierarchical relationship, said first group being a parent group and said second group being a child group. Establishing the second group as a member of the first group may be performed in response to an instruction by a member

In this way, a hierarchical grouping structure can be provided for an instant messaging application or service, and a very large numbers of users can be accommodated in a more ordered fashion. Groups are therefore extended to include both individual users as members, and also to include groups of users as members. Such a hierarchical structure allows message routing to users to be performed in a more controlled manner than in a single group. A hierarchy or tiered structure of groups can be created, with multiple levels or tiers, with each tier possibly including multiple groups (peer groups).

Establishing the second group as a member of the first group may be performed in response to an instruction by an individual member of the first group. The instruction may comprise sending group creation information or group membership information to a server or cloud service for example. Preferably said individual member is an administrator of the first group. Establishing groups and membership of groups may comprise appending or creating a data structure or directory storing user identifiers associated with individual users, and group identifiers linked to one of more user identifiers. Embodiments therefore allow a group identifier to be included as a member of, or linked to, another group identifier. Storage of data defining group membership and group structures, and creation and alteration of such data may be performed at a server or a cloud service provider, or at a user terminal, or may be distributed over a combination of both.

In embodiments, establishing the second group as a member of the first group controls routing of messages, such that messages addressed to the first group are routed also to the second group. This may be performed by creating or updating a group send policy for example. In further embodiments, establishing the second group as a member of the first group controls routing of messages, such that messages addressed to the second group are not routed to the first group. This may be performed by creating or updating a group send policy for example.

In this way, an asymmetrical message routing policy or system can be established, such that messages sent in parent groups are routed to all child groups in the hierarchy or hierarchies below, but messages sent in those child groups are not routed to the hierarchies above. This is advantageous in limiting traffic of messages in very large systems.

This differs from typical distribution lists, which may contain nested distribution lists (DLs) or sub lists. Such distribution lists typically exist for non-realtime communication such as email. Where nested DLs are used, users are typically treated equally, whether they are in the top DL or a nested DL. Therefore, if a recipient in a nested DL replies to a message using a “reply all” function, the message will be sent to all users who received the original message. I.e. the sending is symmetrical.

According to a further aspect of the invention therefore, there is provided a method for instant messaging, comprising receiving a message from a member of a first group addressed to that group, determining all child groups which are subordinate to said parent group, determining all users of said first group and said determined child groups, and routing said message to all determined users.

In embodiments the method is performed at a server or cloud service provider, and may be performed by referencing the first group or an identifier of the first group with a group directory or group send policy linking subordinate child groups.

In embodiments, the method comprises performing processing for routing messages in different groups separately. In this way, processing for different recipients is different depending on the group to which that recipient or that instance of that recipient belongs. All groups may be processed separately, or groups in each layer or level may be processed separately. In such embodiments, the different groups can be determined by an iterative extraction process, successively separating out child groups, with the routing for each child group being performed separately. The separate processing may be performed in parallel, for example by multithread processing, or by multiple instances of roles in a cloud server arrangement.

Processing for routing may be performed with different latency between groups in different levels in embodiments. In this way messages may be delivered with different latency SLA for different levels. Using such a relaxed latency technique reduced processor load.

In embodiments, routing of messages is performed preferentially according to the status of the recipient. That is to say that in embodiments, recipients of the same message, in the same group, will have that message routed differently, and with differing priority, according to the status of the recipient. The status typically refers to whether the recipient is active or passive. Active typically refers to a user who is able to receive and read an IM in real time, by being logged in to the IM service or application, and online. A passive user is typically not able to receive and read messages in real time, and is typically not logged into the service or application, or not online. In this way, separate delivery channels can be defined for recipients of different status. Different delivery channels may involve fewer processes to improve speed of delivery. Desirably routing is performed preferentially to active users.

Similarly, embodiments may perform routing preferentially for recipients in different groups or different levels of groups. In one example, routing is performed preferentially for the top or parent group, over child or subordinate groups.

In embodiments the method may further comprise indicating to a recipient the group of the sender of the message. In this way a recipient is able to quickly and easily distinguish messages originating from different groups, and different levels of groups. The indication may be by graphical means such as a colour or an additional indicator such as a tab or tag to the message. It may be particularly useful to indicate to a recipient messages sent by a member of a group at a higher level than the recipient. The method may further comprise ordering displayed messages in dependence upon the group of the sender of the message, or the level of that group. In embodiments messages may be displayed preferentially based on the originating group, and other messages may be displaced or not displayed accordingly.

According to a further aspect of the invention there is provided An instant messaging system comprising one or more messaging servers; one or more user terminal devices in communication with said one or more messaging servers; a directory storing group information of groups used to route messages to multiple users, wherein said directory includes at least one group which is a member of another group in a parent-child relationship, and wherein said one or more messaging servers is adapted to route messages received from one of said terminal devices to other terminal devices based on said group information.

In embodiments said one or more messaging servers is adapted to route received messages to all members of an addressed group, and to all members of child groups of that addressed group. In embodiments, said one or more messaging servers is adapted not to route, or to prevent routing of messages addressed to a group to members of a parent group of the addressed group.

Determining all child groups which are subordinate to said parent group, determining all users of said first group and said determined child groups, and routing said message to all determined users

According to a yet further aspect of the invention there is provided a method of adding a member to a group of users in an instant messaging system, said system providing instant messaging between registered uses of the system, said method comprising providing at a user terminal or receiving from a user terminal an identifier for a user not registered in the system; and storing the identifier in association with said group of users.

In this way an individual who is not a registered user of the system can be added to a group. This provides convenience and flexibility when creating or updating a group list, for example so that multiple members can be added at substantially the same time irrespective of whether all of those members are registered, with non-registered group members being able to register at a later date.

In embodiments the identifier is an identifier of a communication network other than the instant messaging network, and a telephone number such as a mobile or cellular telephone number may be used, however it may be possible in embodiments to use an email address.

According to a still further aspect of the invention there is provided a method of adding a member to a group of users in an instant messaging system, said system providing instant messaging between registered uses of the system, said method comprising providing at a user terminal of said system an input for an identifier of a user, said identifier not being stored or registered in said user terminal, and storing the identifier in association with said group of users.

By allowing a user to input an identifier, such as a telephone number, manually, for example using a keyed input of each character or number, the user need not store or have stored that identifier on their device or terminal. This is in contrast to many systems whereby addition to a group is constrained to selection from a list of contacts, forcing a user, particularly a group administrator, to store unwanted contact information. This is particularly useful when a member of a group wishes to invite another user, but that member is not an administrator, and must ask an administrator to do so on their behalf.

Identifiers received by a server or system in the ways described above can be stored and used to create or update group membership information or a group directory. This may in turn be used to control message routing, or equivalently a group send policy.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

To assist understanding of the present disclosure and to show how embodiments may be put in effect, reference is made by way of example to the accompanying drawings in which:

FIG. 1 is a schematic block diagram of a communication system,

FIG. 2 shows a functional schematic of an example user terminal suitable for use in the communication system of FIG. 1,

FIG. 3 is message sequence chart illustrating a basic example of instant messaging,

FIG. 4 illustrates tiered or nested user groups,

FIGS. 5 and 6 show flow of message routing in a tiered or nested structure,

FIGS. 7a, 7b, and 7c illustrate graphical user displays for an example IM system,

FIG. 8 illustrates a further graphical user display for an example IM system,

FIG. 9 illustrates functional components for providing an example IM service or system,

FIGS. 10a and 10b show data flows providing an example instant messaging service.

### DETAILED DESCRIPTION OF EMBODIMENTS

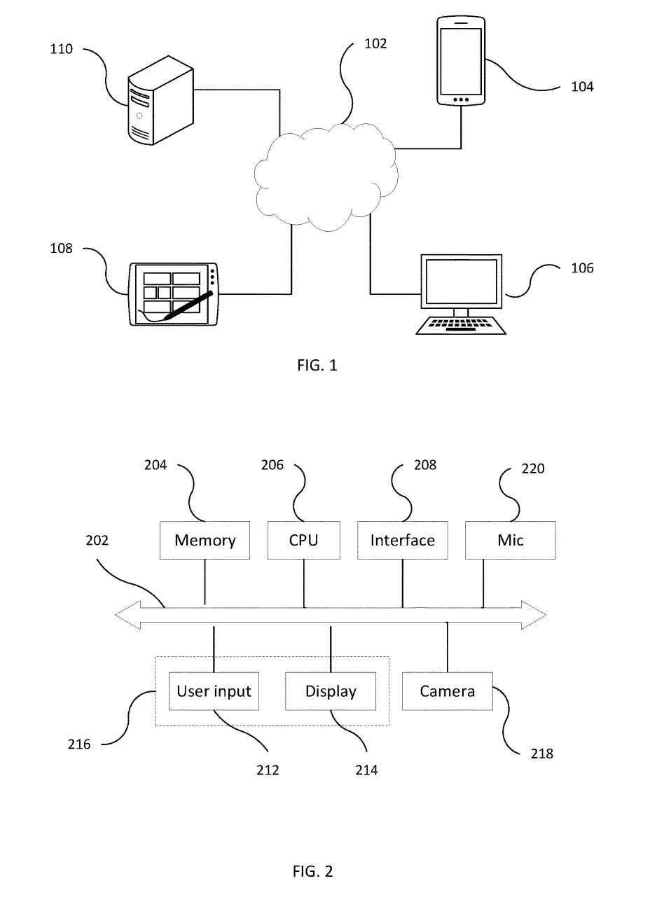

FIG. 1 illustrates an example of a communication system in which an instant messaging system and method can be implemented. A network 102 enables communication and data exchange between user terminals or devices 104-110 which are connected to the network via wired or wireless connection. The network may be a single network, or composed of one or more constituent networks. For example, the network may comprise a wide areas network such as the internet. Alternatively or additionally, the network 102 may comprise a wireless local area network (WLAN), a wired or wireless private intranet (such as within a company or an academic or state institution), and/or the data channel of a mobile cellular network. In an embodiment a device is able to access the internet via a mobile cellular network.

A wide variety of terminal or device types are possible, including a smartphone 104, a laptop or desktop computer 106, a tablet device 108 and a server 110. The server may in some cases act as a network manager device, controlling communication and data exchange between other devices on the network, however network management is not always necessary, such as for some peer to peer protocols.

A functional schematic of an example user terminal suitable for use in the communication system of FIG. 1 for example, is shown in FIG. 2.

A bus 202 connects components including a non-volatile memory 204, and a processor such as CPU 206. The bus 202 is also in communication with a network interface 208, which can provide outputs and receive inputs from an external network such as a mobile cellular network or the internet for example, suitable for communicating with other user terminals. Also connected to the bus is a user input module 212, which may comprise a pointing device such as a mouse or touchpad, and a display 214, such as an LCD or LED or OLED display panel. The display 214 and input module 212 can be integrated into a single device, such as a touchscreen, as indicated by dashed box 216.

Further input/output devices may also be provided, for receiving audio and/or video information from the user, such as a microphone 220 and a camera 218. Furthermore, the i/o devices comprise one or more user input devices enabling applications to receive user inputs and selections from the user. An operating system running on the user terminal is an end-user operating system, i.e. designed for user terminals to provide an interface to the end user, to present information from applications to a user through a graphical user interface presented on a display 214, and to receive back inputs to applications from the user through one or more user input devices.

Programs such as an operating system, a web browser, an instant messaging application, and other applications are stored memory in 204 for example can be executed or run by the CPU, to thereby perform the various operations attributed to them. In the case of an IM service, a client is generally provided as separately installed piece of software such as an app, or a browser-based client. The storage on which the operating system, instant messaging application and other application(s) are stored may comprise any one or more storage media implemented in one or more memory units. E.g. the storage means may comprise an electronic storage medium such as an EEPROM (or “flash” memory) and/or a magnetic storage medium such as a hard disk. Note also that the term “processor” as used herein does not exclude that the processor may comprise multiple processing units.

The network interface 208 enables the user terminal to connect to a packet-based network possibly comprising one or more constituent networks. E.g. in embodiments the network may comprises a wide area internetwork such as that commonly referred to as the Internet. Alternatively or additionally, the network 102 may comprise a wireless local area network (WLAN), a wired or wireless private intranet (such as within a company or an academic or state institution), and/or the data channel of a mobile cellular network. To connect to such a network, the network interface 208 may comprise any of a variety of possible wired or wireless means as will be familiar to a person skilled in the art. For example, if the network 102 comprises the Internet, the network interface 208 may comprise a wired modem configured to connect to the Internet via a wired connection such as a PSTN phone socket or cable or fibre line, or via an Ethernet connection and a local wired network. Or alternatively the network interface 208 may comprise a wireless interface for connecting to the Internet via a wireless access point or wireless router and a local (short-range) wireless access technology such as Wi-Fi, or a mobile cellular interface for connecting to the Internet via a mobile cellular network.

The connection to the network via the network interface 208 allows applications running on the user terminal to conduct communications over the network. User terminals such as that described with reference to FIG. 2 may therefore be adapted to send text and/or audio and/or video data, over a network such as that illustrated in FIG. 1 using a variety of communications protocols/codecs, optionally in substantially real time.

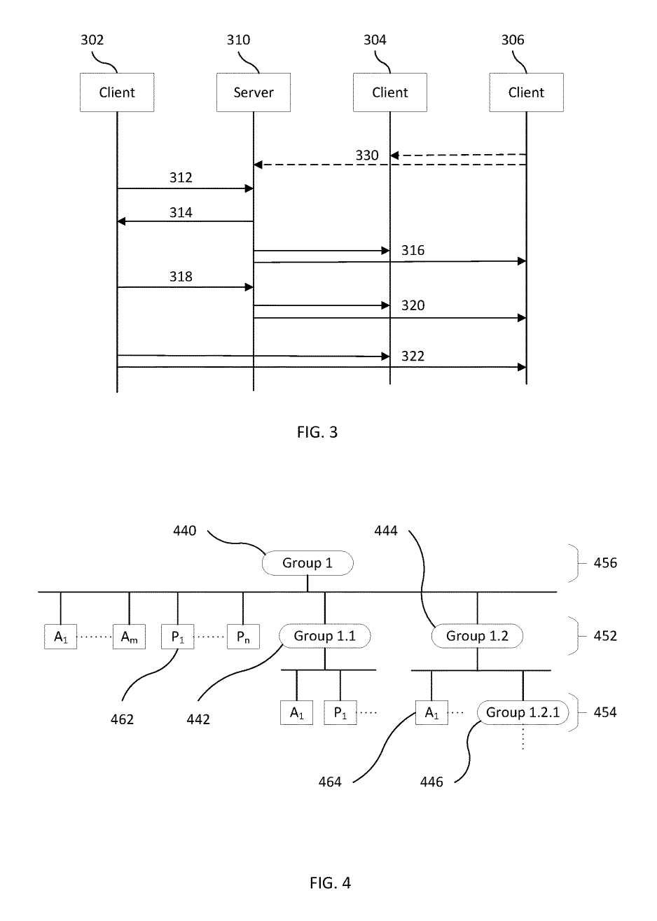

FIG. 3 is message sequence chart illustrating a basic example of instant messaging between a plurality of clients. 302, 304, 306. As noted, a client may be a separately installed piece of software, or a browser-based client operating on a user terminal or device, such as mobile phone, tablet, laptop computer or desktop computer.

When a sending user logs in, the corresponding client 302 sends (312) to a server 310 connection info such as IP address and port, and contacts information including details of any groups the sending user is a member of, if this is not already stored at the server. In this example clients 304 and 306 correspond to users who are contacts of the sending client. The server can check which users from amongst the contact information are logged on or online, and can report back (314) to the client 302. Client 302 can update a display to indicate the status of contacts (e.g. whether they are online or not, or the last time they were logged on or online). The server may notify (316) clients corresponding to the contacts information that client 302 is logged in, and optionally provide the connection information of client 302.

The sending user wishes to send an IM to a group, which includes clients 304 and 306. The message is sent (318) to the server. The server can analyse the message to determine the intended recipients, by receiving the name or ID of the group, and looking up members of that group in stored or received contact information and their connection information, and can forward the message appropriately (320).

In the above described method, a hub-spoke architecture is used, with messaged passing between clients via a server, however a peer to peer architecture is a possible alternative. In a peer to peer system, at 314 the server can also provide connection information (e.g. IP address and port) of contacts who are logged in or online (having been notified of such information from the respective clients, shown dashed line as 330). In this way the client 302 is able to send a message directly (322) to clients 304 and 306, as it has the necessary connection information to access them without the need for a routing intermediary. It is noted that even in a peer to peer session, a server is typically employed to administrate connection information between clients.

Peer to peer architecture is generally more useful for communication where two or more users are connected for a session, such as for a voice call or videoconference for example. A server client, or spoke hub architecture may be more suitable to a text based communication system such as instant messaging.

The above example uses a group arrangement, whereby two or more, or typically three or more users are organised together in a group, having a particular name or identifier. A message can be addressed to the name or identifier of the group, and control logic at the client or server can look up the names and/or addresses of the members of the group, so that the message can be forwarded (i.e. duplicated) to the relevant clients. A group may contain one or more administrators, or admins, who are able to control group properties, such as adding or removing members of the group, or renaming the group for example.

FIG. 4 illustrates how, in examples, a group may contain one or more groups, in a nested or hierarchical structure. It will be seen that a group can have a member of two types—individual or (sub-) group.

Group 1, 440 contains a number of user members, some of whom may be administrator members A₁ to Aₘ, and some of whom may be regular members P₁ to Pₙ. Also included as a member of Group 1, is a sub-group, or child group, Group 1.1 442. This child group includes an admin member A₁, and one or more ordinary members P₁ . . . Group 1.1 contains no further child groups.

Group 1 also contains another child group, Group 1.2 444. This group again includes some individual members, and includes a further sub- or child group, Group 1.2.1 446. This is all that is shown in FIG. 4, but Group 1.2.1 may have individual user members, and could have further sub-groups.

Thus it can be seen that multiple tiers or hierarchical levels are established, by a group structure which can support child or sub-groups. A first level 452 includes user members of Group 1. In some examples names or identifiers (shown as lozenge or oval shapes to distinguish from individual user members) of Groups 1.1 and 1.2 (but not individual members of these groups) can be considered as existing at this level. A second, lower level 454 includes members of Group 1.1 and members of Group 1.2, and it can be considered that a name or identifier of Group 1.2.1 exists at this level also. The name or identifier of Group 1 can be considered at a top or zeroth level 456.

A parent group may have more than one child group, as illustrated in FIG. 4, however it is also possible for a child group to belong to more than one parent group. Furthermore, an individual user or client can belong to multiple groups, at multiple levels, as required. For example, regular member 462 in Group 1 may be the same user as admin member 464 in Group 1.2. Therefore, groups may overlap both inter and intra level in some cases. It is also noted that a group may have only other (sub-) groups as members, and no individual members.

Users will typically only see the groups, for example listed in a summary view, that they are directly part of but can preferably view the current standing of the group on details view so that they can view the parent groups and sub-groups for the group that they are member of.

In a simple (flat) group structure with no nested or sub groups, routing or sending policy or logic is typically simple in that a message sent to a group is sent or made available to all members of that group. If a member of that group relies to the message, that reply is also sent or made available to all members of the group. In other words, all messages sent to a group are made available or delivered to all members of that group always.

With a group structure which includes nested groups, it has been found to be beneficial to establish a more sophisticated message routing policy.

FIG. 5 illustrates an example message routing policy for nested groups.

A first feature of an example routing policy is that all messages sent in parent groups are routed to all child groups that belong to that parent group, and downwards to all members of child groups in the layer below.

This can be seen by considering an example message sent by user 502 of FIG. 5. The message is addressed to Group 1, and is routed to all the members of group as shown by chevrons 510 at a first level. This includes all individual members and Groups 1.1 and 1.2 since these are also members of Group 1. The message is then routed to all the members of child groups 1.1 and 1.2, as indicated by chevrons 512 at a second level. Group 1.2.1 is a member of group 1.2, and therefore the message is routed to this group and all its members also.

A second feature of an example routing policy is that messages sent in a child group are not routed upwards to parent groups or their members.

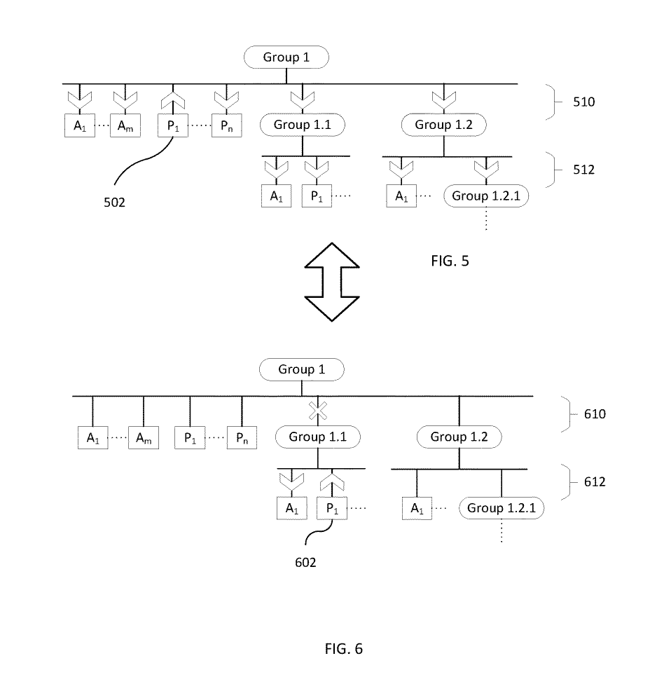

Considering FIG. 6, a message sent by user 602 is routed to all other members of Group 1.1, but does not get routed upwards to Group 1, as indicated by an “X” symbol. For example, the message sent by user 602 may be a reply to the message sent by user 502 in FIG. 5.

It can be seen that these two features effect a “cascaded” or “top down only” communication system. Such a system is asymmetrical when considering replies or responses—a reply to a group message will not necessarily be routed to all the recipients of the original group message. Instead, the reply will only be promulgated to members of the group or groups to which the replying user belongs, and cascaded downwards.

A third feature of an example routing policy is that circular dependency is recognized by the system, and messages are terminated at an appropriate point to avoid flooding.

In examples, a circular nesting of groups may be possible, which would result in messages being routed continuously. In order to prevent this, the system can identify when a message has been routed to all valid recipients once, and terminate further routing.

As illustrated in FIGS. 4 to 6, there may be two types of individual members (in addition to group members) of a group—regular members and administrators with higher privileges. In examples, only administrators of a group can add members to that group, including other groups. Administrators can also remove members of a group, including subgroups, however members may be able to leave a group without the permission of an administrator. An administrator of a group, acting on behalf of the whole group, may be able to leave a higher group of which it is a member.

An administrator of a group may not be able to join that group, as a child group, to another group, as this should be performed by an administrator of that other group. However, a request to join could be lodged, and could then be accepted (or not) by an administrator of that other group.

An administrator of a group at a lower, or child level, should be able to view all of the parent groups to which that group belongs (including grandparent groups and great grandparent groups etc. . . . ), but may not be able to view individual members of parent groups at higher levels.

Typically users in an IM system, either with regular “flat” groups, or employing a hierarchy of groups, are identified by a unique identifier. The unique identifier may be assigned by the instant messaging system/network in examples. However, an identifier such as a telephone number, for example a mobile or cellular telephone number can be used, which is registered with a communications network other than the instant messaging system. In examples, one or more further identifiers can additionally be assigned to a user by the system/network, and linked or indexed to a telephone number if desired.

By using an identifier which is not part of or assigned by the instant messaging system, it is possible in examples to add members who are not yet registered with the instant messaging system. Such a situation may occur for example where a user does not have software installed in a mobile device to provide a client for accessing the server or servers administering the IM system. Such members can be added to a group using, for example a mobile or cellular phone number as an identifier, and such a user or users becomes a “ghost” member of that group. In this state, cannot participate in conversations, and cannot send or receive messages until the register with the IM system (for example, by installing and/or activating the relevant software). Furthermore, such members will not appear to other members who are registered in the IM system. On installing and/or registering with the IM systems, a “ghost” user, who has already been added via a telephone number will automatically appear in the relevant group or groups.

An individual who has been added as a “ghost” member in this way, may not receive any indication, and can remain completely unaware, until he or she joins the IM service. However, it is possible that he or she could be sent a notification, by a service connected to the identifier with which they were added. If the individual was added with a mobile or cell number then, they could be sent an SMS to inform them of such. Alternatively, a user might be added by an email address, and could receive a notification by email.

Furthermore, it is possible in examples for a user to be added by an administrator of a group (in both systems which do and do not support hierarchical grouping) without that administrator requiring the user's details to pre-stored, either on a particular device, or in a store or registry associated with a particular account or user. That is, when adding a user (either an existing user of the IM system, or an individual who has yet to register for the IM system) an administrator can simply enter the details of that user manually. The details, or identifier can be a phone number as discussed above for example or an email address or any other unique identifier. Once entered, such details do not have to be stored by the entering user device or account, and can be forgotten.

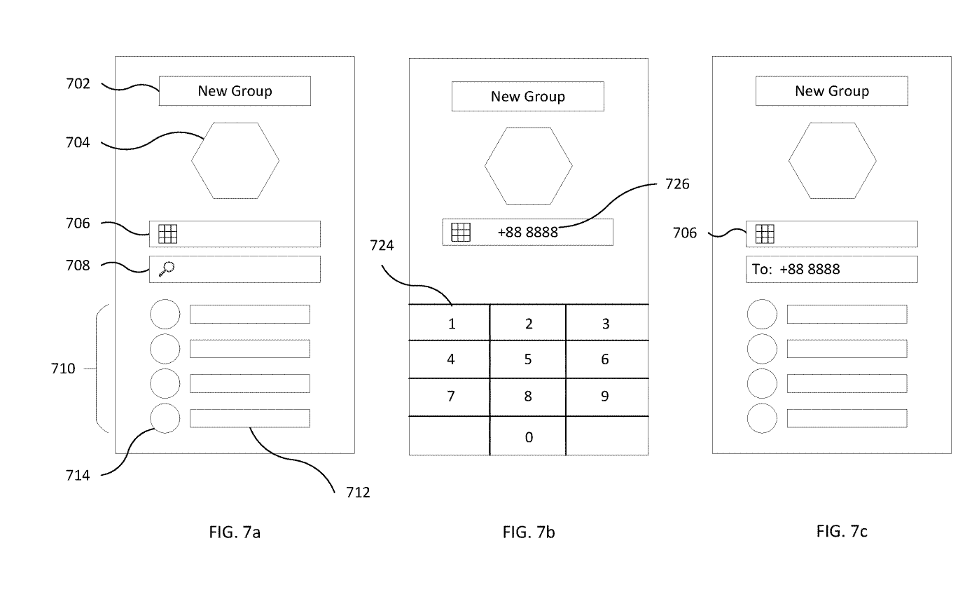

FIGS. 7a-7c illustrate a series of user displays which may be provided on a user terminal, to allow a user to add an individual to an existing or newly created group.

In FIG. 7a, a graphic object 702 indicates the name of the group, and an icon or avatar 704 may be provided to identify or associate with the group. A character input box 706 and a search box 708 are provided. The search box allows a character string or partial character string to be entered and matched against know or stored contacts. Such known contacts can be listed in area 710, and may have a text identifier 712, together with an avatar or icon 714. Known contacts shown in area 710 may include existing groups, which can be added. A group shown in area 710 (which area may be scrolled up or down) can be indicated by a name or graphic in the same way as an individual, and may have a specific icon or device to differentiate it from individual members.

In FIG. 7b, a user has activated the character input box 706, and is adding a user by inputting their telephone number. On activating the box 706, a keypad 724 is displayed. Here numeric characters are shown, the keypad may be alphanumeric to enable letters to be input also, if needed. Text in the form of a partial telephone number 726 can be seen in input box 706, and optionally this can be matched or partially matched to known contacts dynamically, with matches (if any) displayed (not shown) below the input box. In FIG. 7c, it can be seen that once the input characters are confirmed, the input is automatically added to a “To:” field dialog box.

Afterwards, the entry can be confirmed, or sent to add the individual in question, a confirmation screen can be displayed, listing amongst other things the number of members in the group, and possibly a list of member's names or identifiers.

As noted above, the examples of messaging systems and networks described herein allow very large groups or groups of groups to be established, and for messages to be sent within and between such groups. As such, a large number of messages may be delivered to a user, creating an issue of “noise” if the volume of messages prevents a user from viewing the most relevant messages.

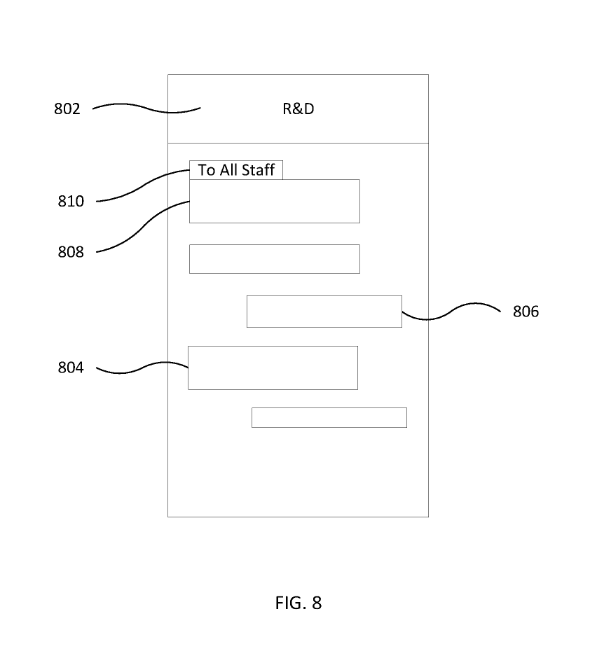

FIG. 8 shows a user display which may be provided on a user terminal, showing a series of sent and received messages as part of a group.

Header 802 shows the name of the group, which is “R&D” here. In the main part of the display, received messages such as message 804 are displayed towards the left, and sent messages such as 806 are displayed towards the right.

Message 808 has been received by virtue of being sent to a parent group of the current group “R&D”. For example, the parent group may be “All Staff”. In this example, messages received via a parent group are displayed differently, and a tab device 810 is attached to the message 808. Here the tab includes text to indicate the group from which it originated. It will be understood however that visual indications to distinguish messages may take a variety of forms, and text size, font, background, colour etc. are a few examples

Typically messages in such a display are shown in chronological order, with the most recent at the top. In this case however, messages from parent groups may be promoted to a higher order, even if they were received at a later time than messages shown below them. Additionally or alternatively such messages may “stick” to the top of the display, with later received messages from within the group (i.e. not from a parent group) being displayed below.

Thus the order of the message in the display, and the appearance of the message may be altered according to the group from which that message originated. In examples a simple system which only distinguishes between messages from within the group, and messages from (any) parent group is used. However, a finer degree of distinction can be provided, for example to distinguish messages by level or tier (so that messages from different groups within the same hierarchical level are not distinguished), or to distinguish particular selected groups, which may be user selected, or distinguish all groups.

In the case of distinguishing messages by level or tier, the rank of the level or tier may dictate the order or sequence in which the messages are displayed.

As very large numbers of members are possible, and because cascading through groups allows a message to be sent to a large number of users, it has been found useful to provide an indication to a user of the number of recipients a message is to be sent. This may be by a text banner displayed either before a message send input is received, or after the send input is received, providing a user an opportunity to confirm or cancel sending, based on the number of recipients. The number of recipients may be an exact number if known, or an approximation. For example if numbers are very large, the approximation may be to the nearest 50, 100, or 100 recipients for example.

Alternatively, an indication may be given in the form of a threshold number, indicating that there are more than the threshold number of recipients. For example, an indication may alert a user that there are more than 50, 100 or 1000 recipients. In this case an indication may not be provided at all if the number of recipients is below a threshold.

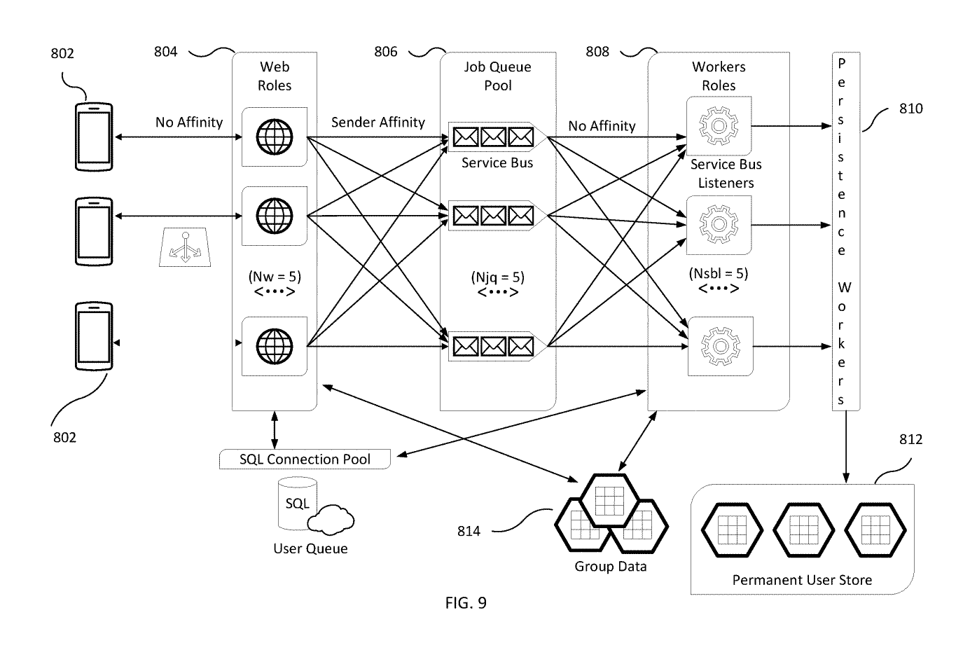

FIG. 9 shows an example of the basic components providing an instant messaging service. In FIG. 9 a cloud server or cloud computing platform is used instead of a dedicated server or servers. In the cloud platform, multiple cloud service roles, comprising a collection of virtual machines, working together to perform tasks under the management of a controller.

A plurality of client terminals 802 connect to the cloud platform via multiple web role instances 804. A load balancer may be provided to balance the load. The web role instances can create job, which are passed to job queue pool 806. Jobs in the job queue pool can be picked and processed by worker roles 808. Persistence workers 810 may also be provided for archiving messages in permanent user store 812. The web roles and worker roles have access to group data storage 814

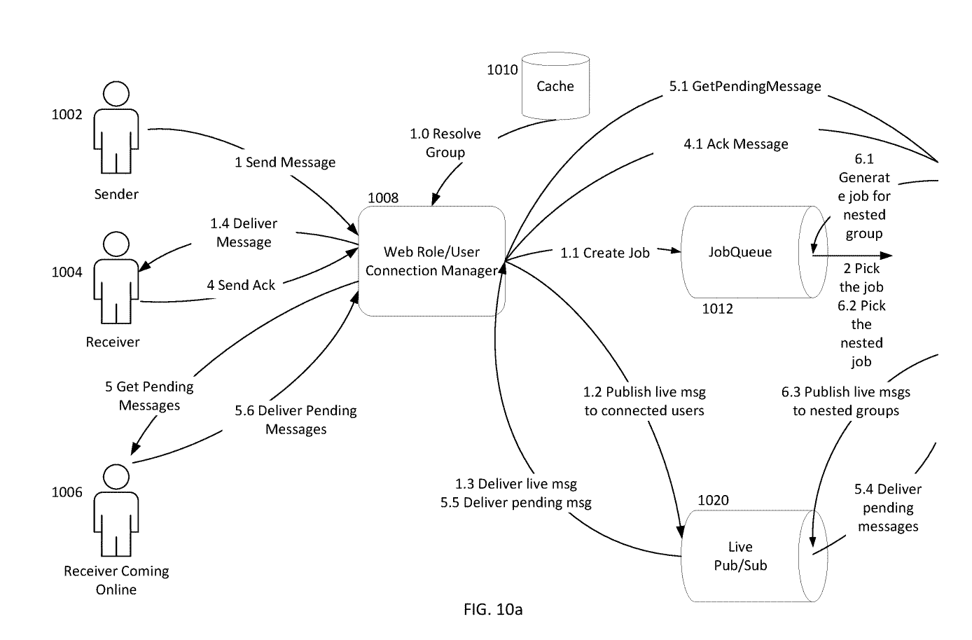

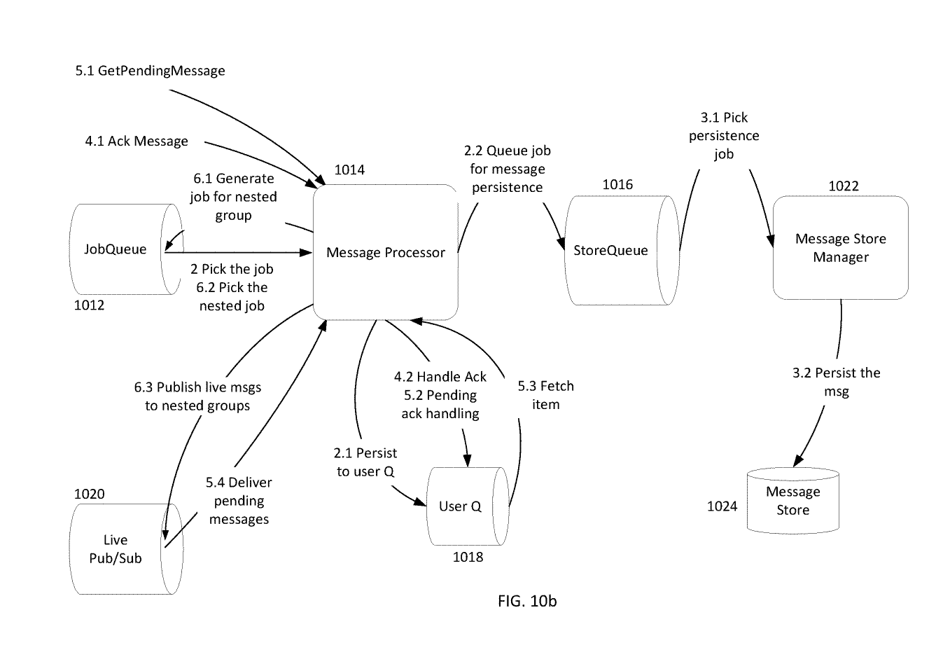

FIGS. 10a and 10b illustrate components and data flows providing an instant messaging service in greater detail. The FIG has been split into FIGS. 10a and 10b for convenience, but should be viewed and are described together.

Users 1002 and 1004 are online, and user 1006 is coming online from an offline state. User 1002 sends a message (1) which is received at Web Role/user connection manager 1008. Information on members of groups, and group hierarchies is stored in cache 1010, and provided (1.0) to web role 1008 to enable nested groups to be identified and for messages to be processed appropriately. Web role 1008 passes (1.2) the message to Live Channel Pub/Sub 1020. From here, the message is delivered (1.4) live to online users via (1.3) a web role 1008, which may be a different web role to that which received the message from user 1002.

Web role 1008 also creates a job (1.1) in job queue 1012, which can be picked (2) by message processor 1014, which may be a worker role for example. The job is passed (2.1) to user queue 1018 for later retrieval if required, and to store (2.2) queue 1016, ultimately for archive (3.1) via message store manager 1022 to (3.2) message store 1024.

Message processor 1014 (or an equivalent instance of a worker role) generates (6.1) a job for nested groups in the job queue 1012, and the nested job is picked (6.2) by processor 1014, (which may be another instance of a worker role). Live messages for nested groups are published (6.3) to live channel 1020, for deliver to live users via a web role similarly to before.

A user or client terminal coming online 1006 can issue a get messages (5) notification to a web role 1008, which in turn issues a get pending message notification (5.1) to message processor 1014. User queue should be storing messages which have not yet been delivered, and hence relevant messages can be retrieved (5.2, 5.3). Such retrieved messages can be sent to live channel 1020, and delivered (5.5, 5.6) to user 1006 via a web role.

In this way it can be seen that a message sent to a group can be received and analysed, based on stored grouping information, to determine nested or child groups to which that message should also be delivered. Jobs can be created iteratively at a job queue for each nested group, and each of these “nested” jobs can be handled by a message processor, which may be an instance of a worker role. Worker processes can therefore be performed in parallel.

For each job, whether or not it is a nested job, the message can be delivered to live users using a live channel, and stored in a user queue for users who are not online, for later retrieval.

In a messaging system with multilevel groups, the memory and processor requirement is dependent on the total number of recipients in the entire hierarchy. To avoid overload of such subsystem, messaging is handled via Live Channel and JobQueue workers in this example. The messages at each level in the hierarchy will be handled by delivering a message to the Live Channel for all direct recipients of a given group, and also in parallel deploying a message in JobQueue for another worker to pick it for each subgroup in a group. The workers are tasked with delivering the messages to groups direct recipients, and further deploying additional JobQueue items/workers for further levels. With such a system, the load of each worker and its latency is a factor of only its direct members, and hence overall load on the system is distributed amongst workers across the machine.

In a messaging system with multilevel hierarchy with real time expectation of message delivery, delivery message to whole hierarchy in one shot is onerous for any worker. The memory and processor usage of such a system is proportional, and linearly increasing with the number of receivers in whole hierarchy. Also, the latency SLA is hard to achieve with single system load increase.

A relaxed latency technique for delivering messages with different latency SLA for various levels is therefore employed in this example. The relaxed latency defines different expectation for delivery of message at varying level, and thus allowing employing multilevel workers processes in parallel for delivery of message at each level.

Furthermore, delivery speed can be tailored amongst different users, or certain users can be prioritised for faster delivery. Delivery can be prioritised first for connected, or online users. Lower delivery priority is assigned to users who are not online or logged on, and these can be further subdivided in terms of delivery priority according to sub-groups, or levels of sub groups, so that higher priority is given to delivery of messages to groups at higher levels.

In an example, messages are delivered to connected users on same web roles as a first priority. Connected users on different web roles follow, by delivering the message to those respective web roles, and then to recipient. The process of delivering messages to connected users, minimises activities on messaging system to only those required. These minimum activities include only delivering message to JobQueues for slower consumption. In the example of FIGS. 10a and 10b, for delivery of messages to online users, only processes 1.1, 1.2, and 1.3 need to be performed by the Web role.

The next level of priority, is to provide messages in a JobQueue(s) to the user queue, which will be made available for fetching for clients which are coming online from offline state. In the example of FIGS. 10a and 10b, this can correspond to processes 2, and 2.1

The last level is message archival queue for long term archival for messages for processing by client or other subsystems, which in the example of FIGS. 10a and 10b may correspond to processes 2.2, 3.1 and 3.2.

As described above, very large groups can be accommodated by using hierarchical groups. As the group size grows, there are certain characteristics that arise in examples. Firstly, group members are less likely to know one another, for example personally or professionally, and secondly group members may not want their private information disclosed to a large number of potentially unknown people. While this problem is more likely with hierarchical groups, it may also exist in more common, IM systems with flat group structures.

Therefore in examples, personal identifiable information (PII) attributes such as phone number are hidden from members of a group. That is, this information is not displayed or accessible on a user terminal. This can be applied as a default setting or rule, with exceptions if required.

A first exception is that PII attributes are visible to an individual if the other individual is already in their phone contacts list. A second exception is that PII attributes of all group members can be made visible to an administrator of that group.

This is particularly applicable for systems that use telephone phone numbers as primary and unique identity, which has become common for real-time chat applications.

It will be understood that the present invention has been described above purely by way of example, and modification of detail can be made within the scope of the invention. Each feature disclosed in the description, and (where appropriate) the claims and drawings may be provided independently or in any appropriate combination.

The various illustrative logical blocks, functional blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. A processor may also be implemented as a one or a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

1. A method comprising
establishing a first group of users in an instant messaging environment;
establishing a second group of users in the instant messaging environment; and
establishing the second group as a member of the first group, in a hierarchical relationship, said first group being a parent group and said second group being a child group.

2. A method according to claim 1, wherein establishing the second group as a member of the first group controls routing of messages, such that messages addressed to the first group are routed also to the second group.

3. A method according to claim 1, wherein establishing the second group as a member of the first group controls routing of messages, such that messages addressed to the second group are not routed to the first group.

4. A method according to claim 1, comprising:
receiving a message from a member of the first group addressed to said first group;
determining all child groups which are subordinate to said parent group;
determining all users of said first group and said determined child groups; and
routing said message to all determined users.

5. A method according to claim 4, wherein processing for routing messages in different groups is performed separately.

6. A method according to claim 5, wherein processing comprises iteratively extracting child groups for processing, each child group being processed separately.

7. A method according to claim 5, wherein processing of each group is performed in parallel.

8. A method according to claim 5, wherein messages are routed with different latency for different groups.

9. A method according to claim 4, wherein routing of messages is performed preferentially according to the status of the recipient.

10. A computer readable storage medium comprising computer readable instructions which when run on a computer cause that computer to perform a method for instant messaging comprising:
receiving a message from a member of a first group addressed to said first group;
determining all child groups which are subordinate to said parent group;
determining all users of said first group and said determined child groups; and
routing said message to all determined users.

11. A computer readable storage medium according to claim 10, wherein processing for routing messages in different groups is performed separately.

12. A computer readable storage medium according to claim 11, wherein processing comprises iteratively extracting child groups for processing, each child group being processed separately.

13. A computer readable storage medium according to claim 11, wherein processing of each group is performed in parallel.

14. A computer readable storage medium according to claim 11, wherein messages are routed with different latency for different groups.

15. A computer readable storage medium according to claim 10, wherein routing of messages is performed preferentially according to the status of the recipient.

16. A computer readable storage medium according to claim 4, wherein routing is performed preferentially according to the level of the group.

17. A computer readable storage medium according to claim 4, the method further comprising indicating to a recipient, the group of the sender of the message.

18. An instant messaging system comprising:
one or more messaging servers;
one or more user terminal devices in communication with said one or more messaging servers;
a directory storing group information of groups used to route messages to multiple users, wherein said directory includes at least one group which is a member of another group; and
wherein said one or more messaging servers is adapted to route messages received from one of said terminal devices to other terminal devices based on said group information.

19. An instant messaging system according to claim 18, wherein said one or more messaging servers is adapted to route received messages to all members of an addressed group, and to all members of child groups of that addressed group.

20. An instant messaging system according to claim 18, wherein said one or more messaging servers is adapted not to route, or to prevent routing of messages addressed to a group, to members of a parent group of the addressed group.
